(19) United States
(12) Patent Application Publication
(10) Pub. No.: US 2005/0183078 A1
(43) Pub. Date: Aug. 18, 2005

(54) Methods and apparatus for referencing thread-local variables in a runtime system

(76) Inventors: Xiaohua Shi, Beijing (CN); Jinzhan Peng, Beijing (CN); Guei-Yuan Lueh, San Jose, CA (US); Gansha Wu, Beijing (CN)

Correspondence Address: HANLEY, FLIGHT & ZIMMERMAN, LLC, 20 N. WACKER DRIVE, SUITE 4220, CHICAGO, IL, 60606, US

(21) Appl. No.: 10/780,208

(22) Filed: Feb. 17, 2004

(51) Int. Cl. G06F 9/45

(52) U.S. Cl. 717/149

(57) ABSTRACT

Methods and apparatus to reference thread-local variables in a runtime system are disclosed. A disclosed method allocates a first node, stores a value in a thread-local variable field in the first node, and identifies a second node in a data structure allocated by a runtime environment while an operating system associated with the runtime environment is in an unlocked condition.

### TECHNICAL FIELD

The present disclosure is directed generally to managed runtime environments and, more particularly, to methods and apparatus to refer to thread-local variables in a runtime system to reduce software execution times.

### BACKGROUND

The need for increased software application portability (i.e., the ability to execute a given software application on a variety of platforms having different hardware, operating systems, etc.), as well as the need to reduce time to market for independent software vendors (ISVs), have resulted in increased development and usage of managed runtime environments.

Managed runtime environments are typically implemented using a dynamic programming language such as, for example, Java and C#. A software engine (e.g., a Java Virtual Machine (JVM), Common Language Runtime (CLR), etc.), which is commonly referred to as a runtime environment, executes the dynamic program language instructions. The runtime environment interposes or interfaces between dynamic program language instructions (e.g., a Java program or source code) to be executed and the target execution platform (i.e., the hardware and operating system(s) of the computer executing the dynamic program) so that the dynamic program can be executed in a platform independent manner.

Dynamic program language instructions (e.g., Java instructions) are not statically compiled and linked directly into native or machine code for execution by the target platform (i.e., the operating system and hardware of the target processing system or platform). Instead, dynamic program language instructions are statically compiled into an intermediate language (e.g., bytecodes).

To improve overall performance, many dynamic programming languages and their supporting managed runtime environments provide infrastructure that enables concurrent programming techniques such as, for example, multi-threading, to be employed. In particular, many dynamic programming languages provide concurrent programming support (e.g., threads) at the language level via thread classes, runnable interfaces, etc.

The runtime environment typically supports features, such as exception handling, garbage collection, runtime helper routines, etc. that require thread-local variables (i.e., variables that are uniquely associated with a thread) to be tracked on a thread scope. For example, when an exception is thrown from a method, the runtime environment unwinds the stack, which requires thread-local variables, to retrieve the frame of the previous method to establish an exception handling hierarchy.

In many operating systems (OSs), the thread-local variables are maintained by the OS (e.g., the pthread thread packages of Linux) and are only accessible through kernel system calls (e.g., pthread_getspecific) that incur high overhead due to trapping in the kernel mode. Unfortunately, the processing overhead associated with the kernel system calls results in a significant increase in execution time. For example, in the case of some well-known Java applications and benchmarks, kernel system calls may consume about ten percent of overall execution time.

### BRIEF DESCRIPTION OF THE DRAWINGS

FIG. 1 is a block diagram of an example code execution system that may be configured to reference thread-local variables.

FIG. 2 is a block diagram of an example implementation of a data structure shown in FIG. 1.

FIG. 3 is a flow diagram of an example process for adding a node to the data structure shown in FIG. 1.

FIG. 4 is an example pseudo code implementation of the example process of FIG. 3.

FIG. 5 is a flow diagram of an example process for finding a node in the data structure shown in FIG. 1.

FIG. 6 is an example pseudo code implementation of the example process of FIG. 5.

FIG. 7 is a flow diagram of an example process for removing a node from the data structure shown in FIG. 1.

FIG. 8 is an example pseudo code implementation of the example process of FIG. 7.

FIG. 9 is a block diagram of an example processor system with which the example methods and apparatus disclosed herein may be implemented.

### DETAILED DESCRIPTION

The following describes example methods, apparatus, and articles of manufacture that provide a code execution system having the ability to reference thread-local variables in a runtime system. While the following disclosure describes systems implemented using software or firmware executed by hardware, those having ordinary skill in the art will readily recognize that the disclosed systems could be implemented exclusively in hardware through the use of one or more custom circuits, such as, for example, application-specific integrated circuits (ASICs) or any other suitable combination of hardware and/or software.

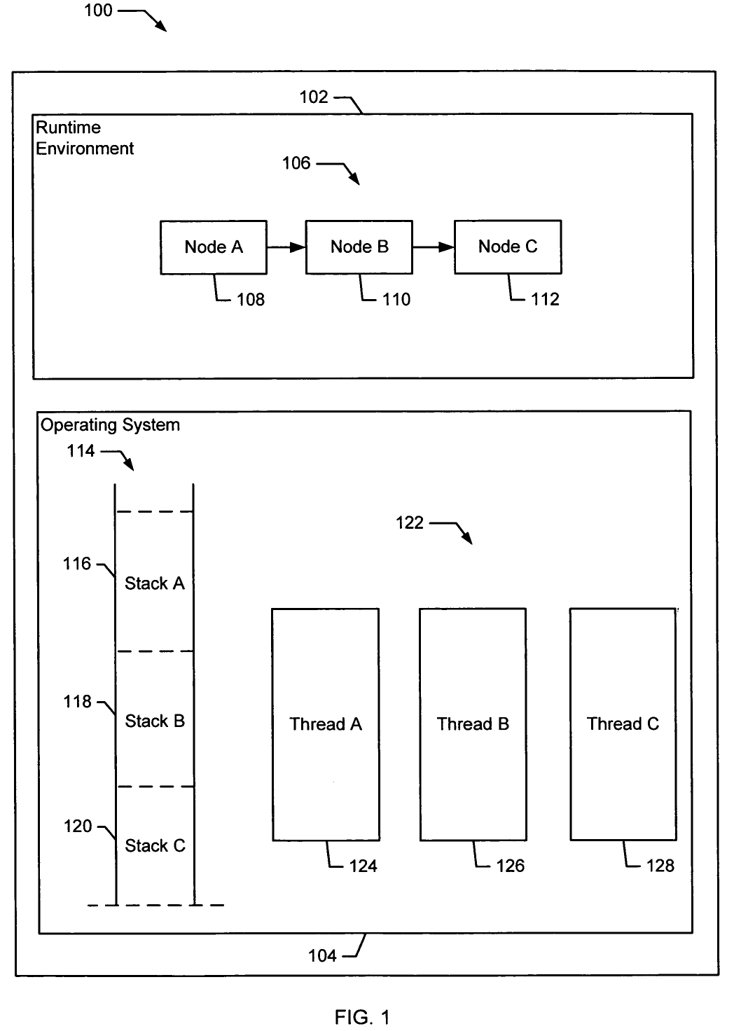

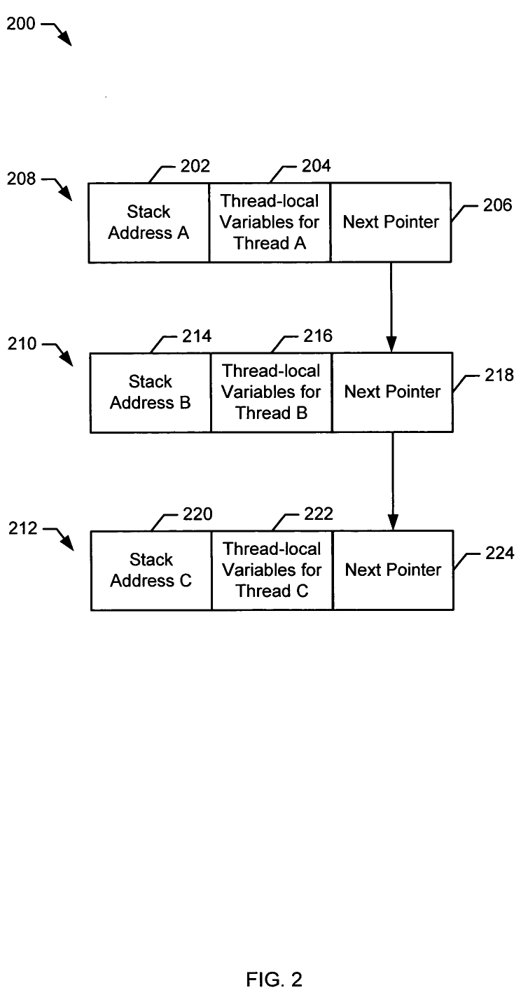

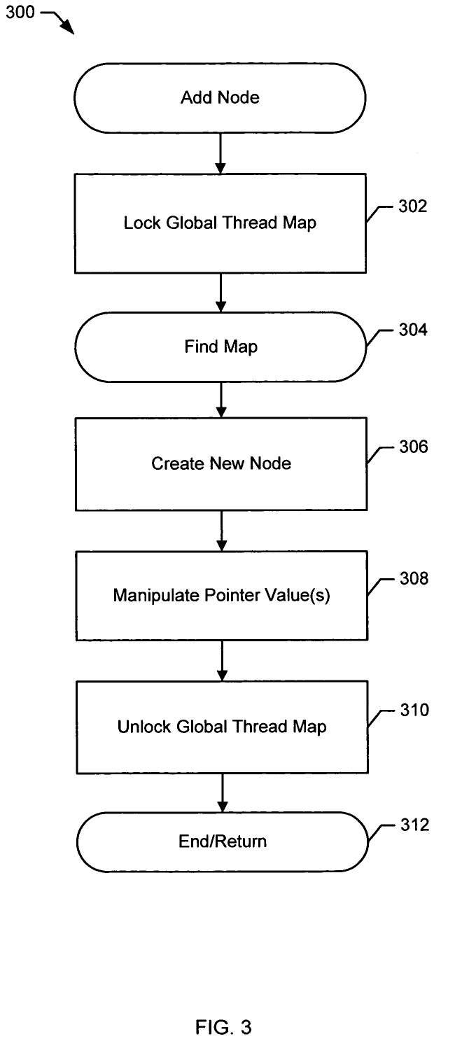

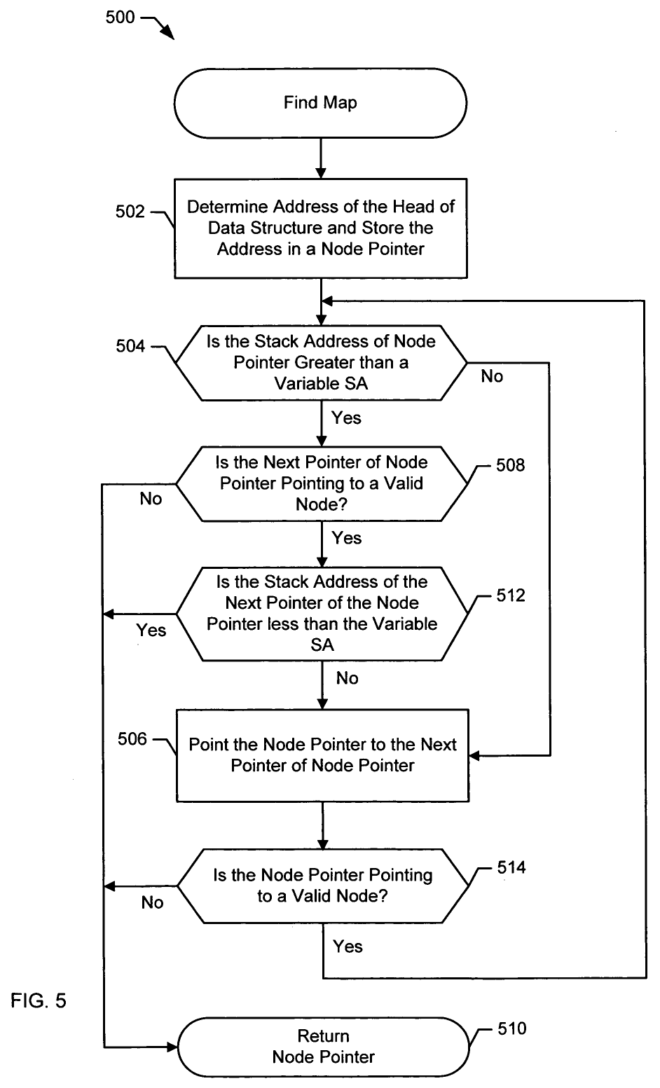

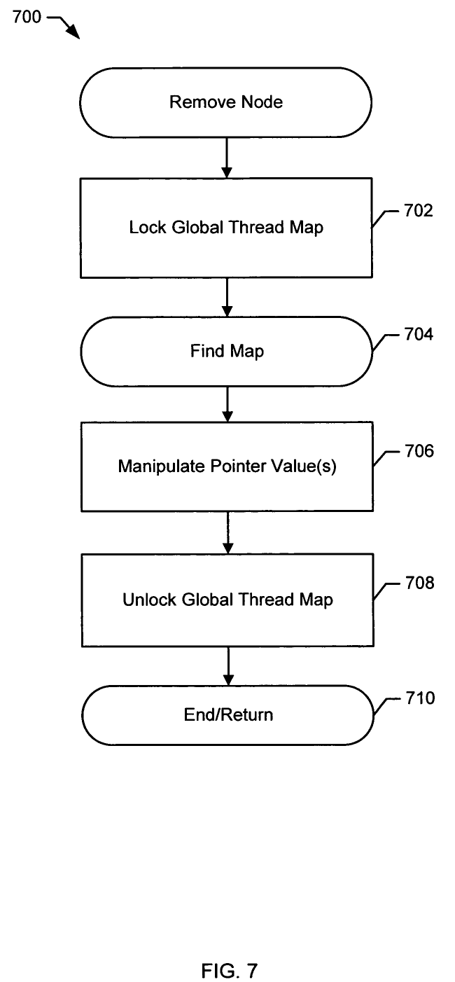

In general, the data structures and methods described below may be used to enhance the performance of a runtime environment by reducing the dependency on kernel system calls for tracking of threads within the runtime environment. More specifically, in tracking threads, the runtime environment may use a data structure, such as a linked list, to store data associated with the threads. Example arrangements of the data structure are described below in conjunction with FIGS. 1 and 2. Operations such as adding a node into the data structure (shown in FIG. 3), finding a node in the data structure (shown in FIG. 5), and removing a node from the data structure (shown in FIG. 7), are described below.

FIG. 1 is a functional block diagram of an example code execution system 100 configured to reference thread-local variables. The code execution system 100 includes a runtime environment 102 and an OS 104.

The runtime environment 102 may be a JVM, a CLR, a Perl virtual machine (e.g., Parrot), etc. The runtime environment 102 includes a data structure 106 that may contain a node A 108, a node B 110, and a node C 112. The data structure 106 may be a linked list-based data structure, an array, a queue-based data structure, a stack-based data structure, a tree-based data structure, or any other suitable dynamically or statically allocated data structure. While three nodes (i.e., node A 108, node B 110, and node C 112) are shown in the data structure 106, the data structure 106 may contain any number of nodes. An example implementation of the structure of the nodes 108, 110, and 112 is discussed in conjunction with FIG. 2.

The OS 104 may be a Linux OS, a Microsoft Windows® OS, a UNIX® OS, etc. The OS 104 includes a plurality of OS stacks 114 including, for example, a stack A 116, a stack B 118, and a stack C 120 and a plurality of threads 122 including, for example, a thread A 124, a thread B 126, and a thread C 128. The OS stacks 114 are information repositories that store program execution history and local data structures. The threads 122 are streams of execution within the OS 104 that can execute independently of each other.

FIG. 2 is a block diagram of an example implementation 200 of the data structure 106 of FIG. 1. The example implementation 200 includes a stack address field A 202, a thread-local variable field 204 for the thread A 124 of FIG. 1, and a next pointer 206 that collectively form a node (i.e. a node 208). The example implementation 200 also includes nodes 210 and 212, which are configured to be similar to the node 208. Further, the nodes 208, 210, and 212 may be similar or identical to the nodes of the example data structure 106 of FIG. 1 (i.e., the nodes 108, 110, and 112). In general, the next pointer 206 may be implemented using any desired type of indirect memory access scheme. For example, a C/C++ pointer, a C++, C#, or Java reference, an assembly language indirect memory reference, etc. may be used to suit the requirements of a particular application.

The node 210 includes fields such as, for example, a stack address field B 214, a thread-local variable field 216 for the thread B 126 of FIG. 1, and a next pointer 218. Similarly, the node 212 also includes, for example, a stack address field C 220, a thread-local variable field 222 for the thread C 128 of FIG. 1, and a next pointer 224.

Each of the stack address fields (e.g., the stack address field A 202, the stack address field B 214, and the stack address field C 220) may be related to the first address of a corresponding OS stack in the plurality of OS stacks 114 (FIG. 1). For example, the stack address field A 202 may contain the first address of the stack A 116 (FIG. 1), the stack address field B 214 may contain the first address of the stack B 118 (FIG. 1), and the stack address field C 220 may contain the first address of the stack C 120 (FIG. 1). Each of the stack address fields 202, 214, and 220 may be used as an identifier to uniquely match a corresponding node to an OS stack. Accordingly, because the threads and OS stacks have a one-to-one relationship, each of the stack address fields 202, 214, and 220 may also be used as an identifier to uniquely match a node to a thread.

The thread-local variable fields (e.g., FIG. 2 shows the thread-local variable field 204, the thread-local variable field 216, and the thread-local variable field 222) are typically used to store data for thread-local variables associated with threads (e.g., the threads 122 of FIG. 1). The thread-local variable fields 204, 216, and 222 may be implemented using a structure, a class, or any other well-known programming data structure.

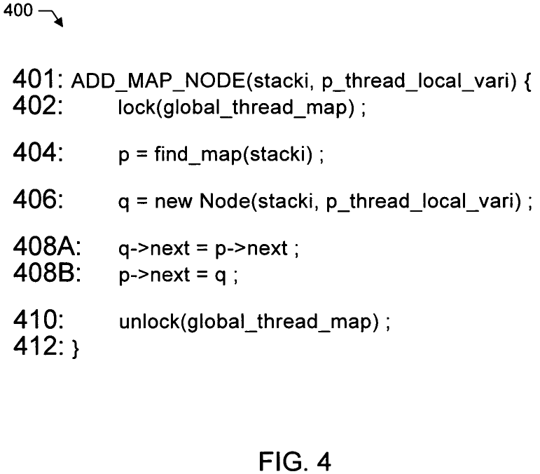

FIG. 3 is a flow diagram of an example process for adding a node to the data structure 106 of FIG. 1 (i.e., an add node process 300) and FIG. 4 is an example pseudo code implementation of the add node process of FIG. 3. The add node process 300 begins execution by locking a global thread map in the runtime environment 102 of FIG. 1 (block 302). The global thread map may be a mutex, a semaphore, or any other suitable synchronization mechanism. For example, the example pseudo code 400 of FIG. 4 includes a lock function invocation instruction 402 that locks the global thread map. If the global thread map is already locked, the lock function invocation instruction 402 results in the blocking of the calling thread until the global thread map becomes available.

After locking the global thread map (block 302), the add node process 300 invokes a find map process (block 304). For example, the example pseudo code 400 of FIG. 4 includes a find₁₃ map function invocation instruction 404 that passes a stacki variable to a find₁₃ map function. The find₁₃ map function invocation instruction 404 also sets a found node (i.e., p) to the node returned by the find₁₃ map function. The find map process is described below in greater detail in conjunction with FIG. 5.

After invoking the find map process (block 304), the add node process 300 creates a new node (block 306). The creation of a new node may be accomplished by allocating memory for the new node and then setting the fields of the new node. For example, the example pseudo code 400 of FIG. 4 includes a new node instruction 406 that creates a new node by passing the stacki variable and a p₁₃ thread₁₃ local₁₃ vari variable to a constructor of a Node class. The new node instruction 406 also sets a variable q to the new object (i.e., the new node) returned from the constructor of the Node class.

After creating a new node (block 306), the add node process 300 manipulates one or more pointer values of a data structure (e.g., the data structure 106 of FIG. 1) (block 308). The pointer values of the data structure may be, for example, the next pointer 206 (FIG. 2), the next pointer 218 (FIG. 2), and/or the next pointer 224 (FIG. 2). The manipulation of the pointer values may be implemented similarly or identically to a first pointer manipulation instruction 408A of FIG. 4 and a second pointer manipulation instruction 408B of FIG. 4. The first pointer manipulation instruction 408A illustrates a well-known technique to set a next pointer of the new node (i.e., q) to the same value as a next pointer of the found node. The second pointer manipulation instruction 408B illustrates a well-known technique to set the next pointer of the found node to point to the new node.

After manipulating the pointer values of the data structure (block 308), the add node process 300 unlocks the global thread map (block 310). For example, the example pseudo code 400 of FIG. 4 includes an unlock function invocation instruction 410 that unlocks the global thread map. If the global thread map is locked, the unlock function invocation instruction 410 results in one of the blocked threads being signaled to run and acquire the lock. After unlocking the global thread map (block 310), the add node process 300 ends and/or returns control to any calling routine(s) (block 312).

Turning in detail to FIG. 4 the example pseudo code 400 (i.e., the ADD₁₃ MAP₁₃ NODE code block 400) includes a function signature and start of function bracket 401 and an end of function bracket 412. The ADD₁₃ MAP₁₃ NODE code block 400 also includes, the lock function invocation instruction 402, the find₁₃ map function invocation instruction 404, the new node instruction 406, the first pointer manipulation instruction 408A, the second pointer manipulation instruction 408B, and the unlock function invocation instruction 410.

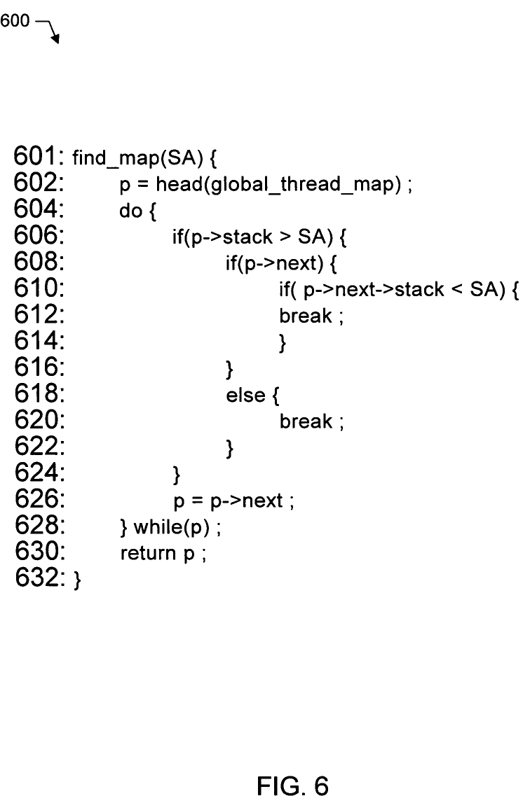

FIG. 5 is a flow diagram of an example process for finding a node in the data structure 106 of FIG. 1 (i.e., a find map process 500) and FIG. 6 is an example pseudo code implementation of the find map process 500 of FIG. 5. The find map process 500 directly or indirectly returns thread-local variable information from the data structure 106 that is stored in the runtime environment 102 of FIG. 1 without locking the OS, which is not the case with the kernel system calls used by known systems.

The find map process 500 begins execution by determining an address of a head node of the data structure 106 of FIG. 1 and storing the address in a node pointer (block 502). For example, pseudo code 600 of FIG. 6 includes a head function call invocation instruction 602 that retrieves the head of the data structure 106 (e.g., the node A 108 of FIG. 1). The head function call invocation instruction 602 also stores the head of the data structure in a node pointer (i.e., p). As is known to those having ordinary skill in the art, the implementation of a head function is a well-known technique that may be used to find the first node in a data structure.

After determining the address of the head node of the data structure 106 of FIG. 1 and storing the address in the node pointer (block 502), the find map process 500 determines if the stack address field of the node pointer is greater than a stack address variable SA (block 504). For example, the example pseudo code 600 of FIG. 6 includes a first conditional instruction 606 that determines if a stack address field of a node pointer is greater than the variable SA. The variable SA is a stack address and, for example, may contain the same value as the first address of the stack A 116 (FIG. 1), the first address of the stack B 118 (FIG. 1), the first address of the stack C 120, etc. The variable SA may be passed as a parameter to the example pseudo code 600 of FIG. 6 may be implemented as a global variable, or may be established using any suitable data passing technique. If the stack address field of the node pointer is not greater than the variable SA (block 504), the find map process 500 points the node pointer to the next pointer of the node pointer (block 506). For example, the example pseudo code 600 of FIG. 6 includes a pointer manipulation instruction 626 that points a node pointer to a next pointer of the node pointer.

On the other hand, if the stack address field of the node pointer is greater than the variable SA (block 504), the find map process 500 determines if the next pointer of the node pointer is pointing to a valid node (block 508). For example, the example pseudo code 600 of FIG. 6 includes a second conditional instruction 608 that checks if a node pointer is pointing to a valid node. If the next pointer of the node pointer is not pointing to a valid node (block 508), the find map process 500 returns the node pointer and, thus, returns control to any calling routine(s) (block 510). For example, the example pseudo code 600 of FIG. 6 includes a return instruction 630 that returns a node pointer and, thus, returns control to any calling routine(s).

On the other hand, if the next pointer of the node pointer is pointing to a valid node (block 508), the find map process 500 determines if the stack address field of the next pointer of the node pointer is less than the variable SA (block 512). For example, the example pseudo code 600 of FIG. 6 includes a third conditional instruction 610 that checks if a stack address field of a next pointer of a node pointer is less than the variable SA. If the stack address field of the next pointer of the node pointer is less than the variable SA (block 512), the find map process 500 returns the node pointer and, thus, returns control to any calling routine(s) (block 510).

If the stack address field of the next pointer of the node pointer is not less than the variable SA at block 512, the find map process 500 points the node pointer to the next pointer of the node pointer (block 506) and determines if the node pointer is pointing to a valid node (block 514). For example, the example pseudo code 600 of FIG. 6 includes an end of do-while instruction 628 that checks if a node pointer is pointing to a valid node. If the node pointer is pointing to a valid node (block 514), the find map process 500 loops back to block 504. On the other hand, if the node pointer is not pointing to a valid node (block 514), the find map process 500 returns the node pointer and, thus, returns control to any calling routine(s) (block 510).

Turning in detail to FIG. 6 the example pseudo code 600 (i.e., the find_map code block 600) includes a function signature and start of function bracket 601, a start of do-while instruction 604, a first break instruction 612, an end of third conditional instruction 614, an end of second conditional instruction 616, a fourth conditional instruction 618, a second break instruction 620, an end of fourth conditional instruction 622, an end of first conditional instruction 624, and an end of function bracket 632. The find₁₃ map code block 600 also includes the head function call invocation instruction 602, the first conditional instruction 606, the second conditional instruction 608, the third conditional instruction 610, the pointer manipulation instruction 626, the end of do-while instruction 628, and the return instruction 630.

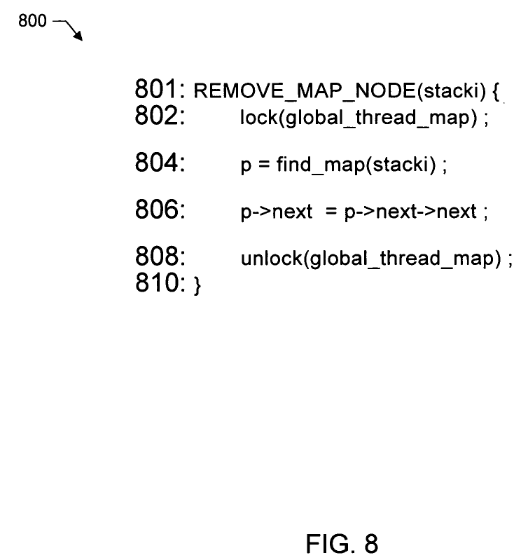

FIG. 7 is a flow diagram of an example process for removing a node from the data structure 106 of FIG. 1 (i.e., a remove node process 700) and FIG. 8 is an example pseudo code implementation of the remove node process 700 of FIG. 7. The remove node process 700 begins execution by locking a global thread map in the runtime environment 102 of FIG. 1 (block 702). The global thread map may be a mutex, a semaphore, or any other suitable synchronization mechanism. For example, the example pseudo code 800 of FIG. 8 includes a lock function invocation instruction 802 that locks the global thread map. If the global thread map is already locked, the lock function invocation instruction 802 results in the blocking of the calling thread until the global thread map becomes available.

After locking the global thread map (block 702), the remove node process 700 invokes a find map process (block 704). For example, the example pseudo code 800 of FIG. 8 includes a find₁₃ map function invocation instruction 804 that passes a stacki variable to a find₁₃ map function. The find₁₃ map function invocation instruction 804 also sets a found node (i.e., p) to the node returned by the find₁₃ map function. The find map process is described above in greater detail in conjunction with FIG. 5.

After invoking the find map process (block 704), the remove node process 700 manipulates pointer values of the data structure 106 of FIG. 1 (block 706). The pointer values of the data structure 106 may be, for example, the next pointer 206 (FIG. 2), the next pointer 218 (FIG. 2), and/or the next pointer 224 (FIG. 2). The manipulation of the pointer values may be implemented similarly or identically to a pointer manipulation instruction 806 of FIG. 8. The pointer manipulation instruction 806 illustrates a well-known technique to set a next pointer of the found node to the same value as a next pointer of a next pointer of the found node.

After manipulating the pointer values of the data structure 106 of FIG. 1 (block 706), the remove node process 700 unlocks the global thread map (block 708). For example, FIG. 8 includes an unlock function invocation instruction 808 that unlocks the global thread map. If the global thread map is locked, the unlock function invocation instruction 808 results in one of the blocked threads being signaled to run and acquire the lock. After unlocking the global thread map (block 708), the remove node process 700 ends and/or returns control to any calling routine(s) (block 710).

Turning in detail to FIG. 8 the example pseudo code 800 (i.e., the REMOVE₁₃ MAP₁₃ NODE code block 800) includes a function signature and start of function bracket 801 and an end of function bracket 810. The REMOVE₁₃ MAP₁₃ NODE code block 800 also includes the lock function invocation instruction 802, the find₁₃ map function invocation instruction 804, the pointer manipulation instruction 806, and the unlock function invocation instruction 808.

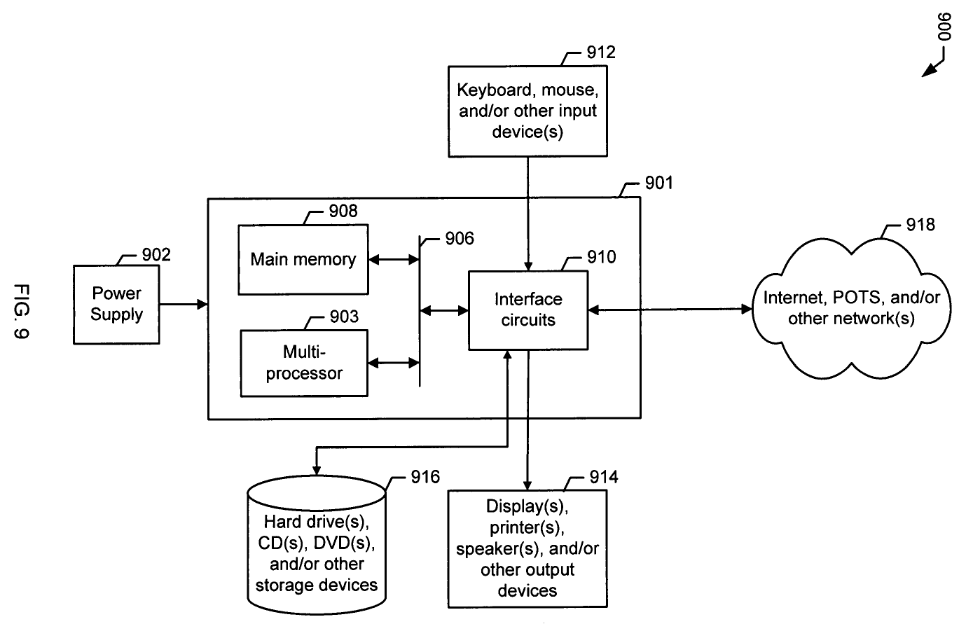

FIG. 9 is a block diagram of a computer system 900 that may implement the example apparatus and methods or processes described herein. The computer system 900 may be a server, a personal computer (PC), a personal digital assistant (PDA), an Internet appliance, a cellular telephone, or any other computing device. In one example, the computer system 900 includes a main processing unit 901 powered by a power supply 902. The main processing unit 901 may include a multi-processor 903 communicatively coupled by a system interconnect 906 to a main memory device 908 and to one or more interface circuits 910. In one example, the system interconnect 906 is an address/data bus. Of course, a person of ordinary skill in the art will readily appreciate that interconnects other than busses may be used to connect the multi-processor 903 to the main memory device 908. For example, one or more dedicated lines and/or a crossbar may be used to connect the multi-processor 903 to the main memory device 908.

The multi-processor 903 may include one or more of any type of well-known processor, such as a processor from the Intel® Pentium® family of microprocessors, the Intel® Itanium® family of microprocessors, and/or the Intel® XScale® family of processors. In addition, the multi-processor 903 may include any type of well-known cache memory, such as static random access memory (SRAM).

The main memory device 908 may include dynamic random access memory (DRAM) and/or any other form of random access memory. For example, the main memory device 908 may include double data rate random access memory (DDRAM). The main memory device 908 may also include non-volatile memory. In one example, the main memory device 908 stores a software program which is executed by the multi-processor 903 in a well-known manner. The main memory device 908 may store one or more compiler programs, one or more software programs, and/or any other suitable program capable of being executed by the multi-processor 903.

The interface circuit(s) 910 may be implemented using any type of well-known interface standard, such as an Ethernet interface and/or a Universal Serial Bus (USB) interface. One or more input devices 912 may be connected to the interface circuits 910 for entering data and commands into the main processing unit 901. For example, an input device 912 may be a keyboard, mouse, touch screen, track pad, track ball, isopoint, and/or a voice recognition system.

One or more displays, printers, speakers, and/or other output devices 914 may also be connected to the main processing unit 901 via one or more of the interface circuits 910. The display 914 may be a cathode ray tube (CRT), a liquid crystal display (LCD), or any other type of display. The display 914 may generate visual indications of data generated during operation of the main processing unit 901. The visual indications may include prompts for human operator input, calculated values, detected data, etc.

The computer system 900 may also include one or more storage devices 916. For example, the computer system 900 may include one or more hard drives, a compact disk (CD) drive, a digital versatile disk drive (DVD), and/or other computer media input/output (I/O) devices.

The computer system 900 may also exchange data with other devices via a connection to a network 918. The network connection may be any type of network connection, such as an Ethernet connection, digital subscriber line (DSL), telephone line, coaxial cable, etc. The network 918 may be any type of network, such as the Internet, a telephone network, a cable network, and/or a wireless network.

While FIGS. 4, 6, and 8 are referred to as functions, the code blocks 400, 600, and 800 may be alternatively implemented using a macro, a constructor, a plurality of inline instructions, or any other programming construct.

As shown in FIGS. 3, 5, and 7, the processes 300, 500, and 700 may be implemented using one or more software programs or sets of machine readable instructions that are stored on a machine readable medium (e.g., the main memory 908 and/or the storage devices 916 of FIG. 9) and executed by one or more processors (e.g., the multi-processor 903 of FIG. 9). However, some or all of the blocks of the processes 300, 500, and 700 may be performed manually and/or by some other device. Additionally, although the processes 300, 500, and 700 are described with reference to the flow diagram illustrated in FIGS. 3, 5, and 7, persons of ordinary skill in the art will readily appreciate that many other methods of performing the processes 300, 500, and 700 may be used instead. For example, the order of many of the blocks may be altered, the operation of one or more blocks may be changed, blocks may be combined, and/or blocks may be eliminated.

Although certain apparatus, methods, and articles of manufacture have been described herein, the scope of coverage of this patent is not limited thereto. On the contary, this patent covers every apparatus, method and article of manufacture fairly falling within the scope of the appended claims either literally or under the doctrine of equivalents.

1. A method comprising:
allocating a first node;
storing a value in a thread-local variable field in the first node; and
identifying a second node in a data structure allocated by a runtime environment while an operating system associated with the runtime environment is in an unlocked condition.

2. A method as defined in claim 1, further comprising:
storing a second value in a stack address field in the first node, wherein the stack address field is associated with a stack allocated by the operating system; and
establishing a relationship between the first and second nodes in the data structure based on a value of the stack address field.

3. A method as defined in claim 2, wherein the relationship between the first and second nodes comprises a value in a stack address field in the second node that is greater than the second value in the stack address field in the first node.

4. A method as defined in claim 1, wherein the thread-local variable field comprises a high-level language data structure.

5. A method as defined in claim 4, wherein the high-level language data structure comprises at least one of a C/C++ structure, a C++ class, a Java class, and a C# class.

6. A method as defined in claim 1, wherein the thread-local variable field comprises an indirect reference.

7. A method as defined in claim 6, wherein the indirect reference comprises at least one of a C/C++ pointer, a Java reference, a C++ 0 reference, a C# reference, and an assembly language indirect memory reference.

8. A method as defined in claim 1, wherein the first node comprises at least one of a statically allocated node and a dynamically allocated node.

9. A method as defined in claim 1, wherein the data structure comprises at least one of a linked list-based data structure, an array, a queue-based data structure, a stack-based data structure, and a tree-based data structure.

10. A method as defined in claim 1, wherein the runtime environment comprises a virtual machine.

11. An apparatus comprising:
a memory; and
a processor coupled to the memory and configured to:
allocate a first node;
store a value in a thread-local variable field in the first node; and
identify a second node in a data structure allocated by a runtime environment while an operating system associated with the runtime environment is in an unlocked condition.

12. An apparatus as defined in claim 11, wherein the processor is further configured to:
store a second value in a stack address field in the first node, wherein the stack address field is associated with a stack allocated by the operating system; and
establish a relationship between the first and second nodes in the data structure based on a value of the stack address field.

13. An apparatus as defined in claim 12, wherein the relationship between the first and second nodes comprises a value in a stack address field in the second node that is greater than the second value in the stack address field in the first node.

14. An apparatus as defined in claim 11, wherein the thread-local variable field comprises a high-level language data structure.

15. An apparatus as defined in claim 14, wherein the high-level language data structure comprises at least one of a C/C++ structure, a C++ class, a Java class, and a C# class.

16. An apparatus as defined in claim 11, wherein the thread-local variable field comprises an indirect reference.

17. An apparatus as defined in claim 16, wherein the indirect reference comprises at least one of a C/C++ pointer, a Java reference, a C++ reference, a C# reference, and an assembly language indirect memory reference.

18. An apparatus as defined in claim 11, wherein the first node comprises at least one of a statically allocated node and a dynamically allocated node.

19. An apparatus as defined in claim 11, wherein the data structure comprises at least one of a linked list-based data structure, an array, a queue-based data structure, a stack-based data structure, and a tree-based data structure.

20. An apparatus as defined in claim 11, wherein the runtime environment comprises a virtual machine.

21. A machine readable medium having instructions stored thereon that, when executed, cause a machine to:
allocate a first node;
store a value in a thread-local variable field in the first node; and
identify a second node in a data structure allocated by a runtime environment while an operating system associated with the runtime environment is in an unlocked condition.

22. A machine readable medium as defined in claim 21, having instructions stored thereon that, when executed, cause the machine to:
store a second value in a stack address field in the first node, wherein the stack address field is associated with a stack allocated by the operating system; and
establish a relationship between the first and second nodes in the data structure based on a value of the stack address field.

23. A machine readable medium as defined in claim 22, wherein the relationship between the first and second nodes comprises a value in a stack address field in the second node that is greater than the second value in the stack address field in the first node.

24. A machine readable medium as defined in claim 21, wherein the thread-local variable field comprises a high-level language data structure.

25. A machine readable medium as defined in claim 24, wherein the high-level language data structure comprises at least one of a C/C++ structure, a C++ class, a Java class, and a C# class.

26. A machine readable medium as defined in claim 21, wherein the thread-local variable field comprises an indirect reference.

27. A machine readable medium as defined in claim 26, wherein the indirect reference comprises at least one of a C/C++ pointer, a Java reference, a C++ reference, a C# reference, and an assembly language indirect memory reference.

28. A machine readable medium as defined in claim 21, wherein the first node comprises at least one of a statically allocated node and a dynamically allocated node.

29. A machine readable medium as defined in claim 21, wherein the data structure comprises at least one of a linked list-based data structure, an array, a queue-based data structure, a stack-based data structure, and a tree-based data structure.

30. A machine readable medium as defined in claim 21, wherein the runtime environment comprises a virtual machine.
